(19) United States
(12) Patent Application Publication
(10) Pub. No.: US 2004/0052002 A1
(43) Pub. Date: Mar. 18, 2004

(54) Voice coil motor for a hard disk drive

(76) Inventors: Jeffery L. Wang, Tai Po (HK); Liu Jun Zhang, Dongguan City (CN); Ping Shang, Dongguan City (CN); Da Qing Huang, Dongguan City (CN); Ji Yang, Dongguan City (CN)

Correspondence Address: KENYON & KENYON, Suite 600, 333 W. San Carlos, Street, San Jose, CA, 95110-2711, US

(21) Appl. No.: 10/364,188

(22) Filed: Feb. 10, 2003

(30) Foreign Application Priority Data
Sep. 16, 2002 (WO) PCT/CN02/00657

(51) Int. Cl. G11B 5/55

(52) U.S. Cl. 360/264.7

(57) ABSTRACT

An actuator driving mechanism and a method of manufacture for that mechanism are disclosed. In one embodiment, the actuator driving mechanism includes a statically located stator generating a variable magnetic field to act upon a mobile rotator generating a permanent magnetic field. In a further embodiment, the stator includes a set of driving coils to generate the variable magnetic field and the rotator includes a permanent magnet coupled to a holding frame.

### BACKGROUND INFORMATION

The present invention relates to magnetic hard disk drives. More specifically, the present invention relates to a method of assembling actuator driving mechanisms.

In the art today, different methods are utilized to improve recording density of hard disk drives. FIG. 1 provides an illustration of a typical disk drive. The typical disk drive has a head gimbal assembly (HGA) configured to read from and write to a magnetic hard disk 101. The HGA and the magnetic hard disk 101 are mounted to the base 102 of a main board 103. The disk 101 is rotated relative to the base 102 by a spindle motor 104. The HGA typically includes an actuator arm 105 and a load beam 106. The HGA supports and positions a magnetic read/write slider 107 above the magnetic hard disk 101. The HGA is rotated relative to the base 102 along the axis of a bearing assembly 108. The HGA is rotated by a magnetic field generated between a yoke 109 and a magnetic block 110. A relay flexible printed circuit 111 connects a board unit 112 to the magnetic read/write slider 107. A cover 113 protects the hard drive components as they operate. Often, the cover is attached by a set of screws 114.

FIG. 2 provides an illustration of a head actuator mechanism as configured in the prior art. The HGA, in this embodiment including an actuator arm 105 and a loadbeam 106, are coupled to an actuator driving mechanism. In one embodiment, more than one HGA are coupled to the actuator driving mechanism. The actuator driving mechanism can include a driving coil 201, also called a voice coil, attached to a coil holding frame 202. The magnetic field generated by the yoke 109 and magnetic block 110 acts upon the driving coil 201 causing the coil holding frame 202, and by extension the HGA, to move. The HGA and actuator driving mechanism pivot around the bearing assembly 108. A spacer 203 separates each HGA and actuator driving mechanism from the other HGA's and driving mechanisms on the bearing assembly 108.

FIG. 3 provides an illustration of the assembled head actuator mechanism. The loadbeam 107 is coupled to actuator arm 108 to form the HGA. The driving coil 201 is coupled to the coil holding frame 202 to form the actuator driving mechanism. The HGA is bonded to the actuator driving mechanism. The entire head actuator mechanism pivots on the bearing assembly.

FIG. 4 provides an illustration of a driving coil 201 as it passes through a magnetic field. The driving coil 201 and the coil holding frame 202 pass through a magnetic field 401 created by the yoke 109 and the magnetic block 110 coupled to the base 102. An electric current is sent through the driving coil 201, creating a second magnetic field. The two magnetic fields interact causing the driving coil 201, as well as the frame 202 holding the driving coil 201, to move. The movement of the holding frame forces the head gimbal assembly to move in the same tangential direction.

The current design of the actuator driving mechanism has a number of drawbacks. Coupling the driving coil to the frame, as well as coupling the frame to the HGA, leaves numerous opportunities for the driving coil to become damaged. Distortion caused by the expansion and contraction due to the difference in thermal expansion coefficients of the plastic bobbins and the metallic coil may lead to a major resonance mode affecting the positioning of the transducer head on the magnetic disc. Additionally, the current magnet and yoke construction occupies a great deal of space.

### BRIEF DESCRIPTION OF THE DRAWINGS

FIG. 1 provides an illustration of a typical disk drive.

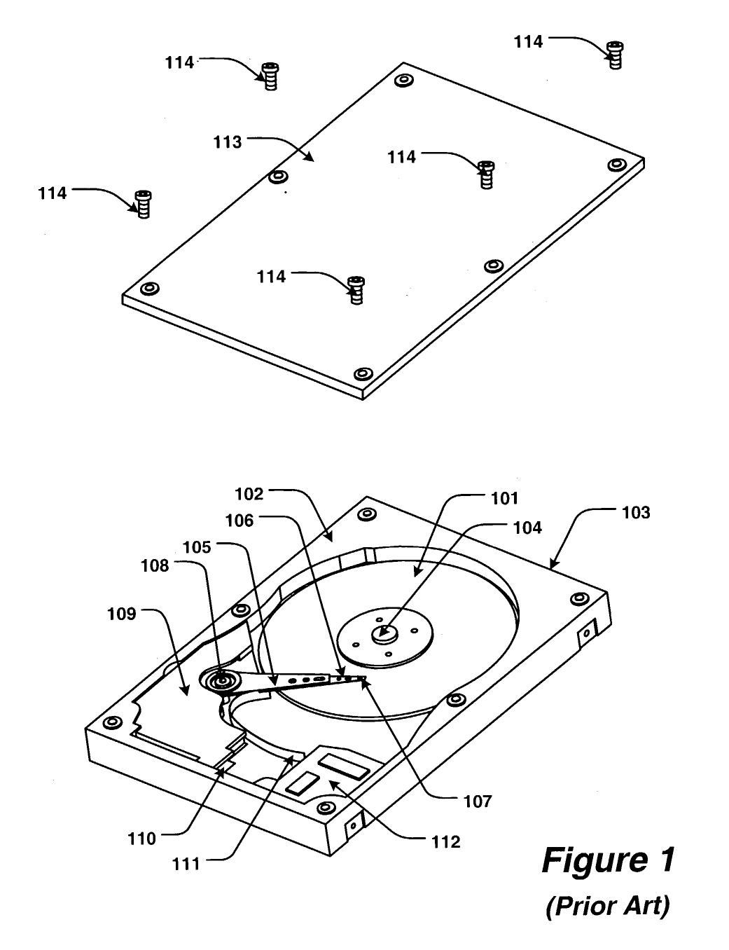

FIG. 2 provides an illustration of a head actuator mechanism as configured in the prior art.

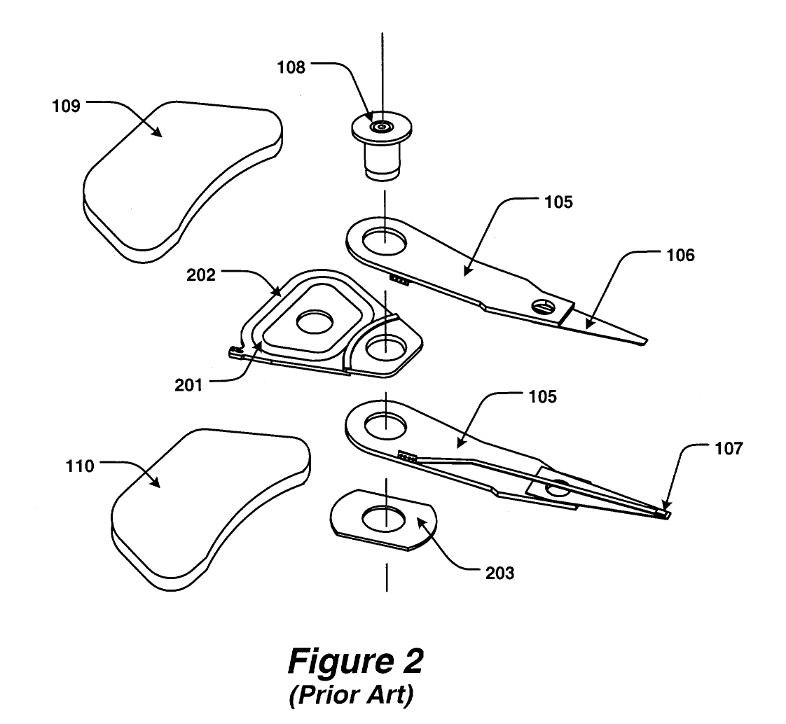

FIG. 3 provides an illustration of the assembled head actuator mechanism.

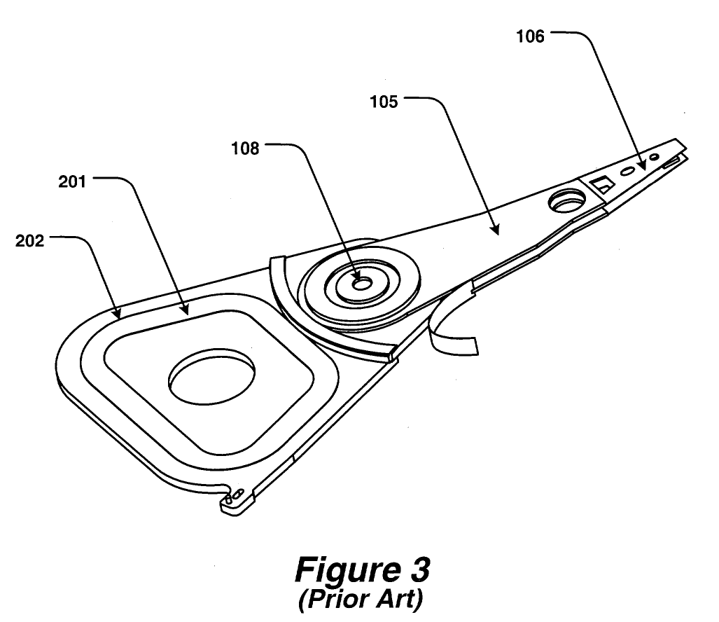

FIG. 4 provides an illustration of a driving coil as it passes through a magnetic field.

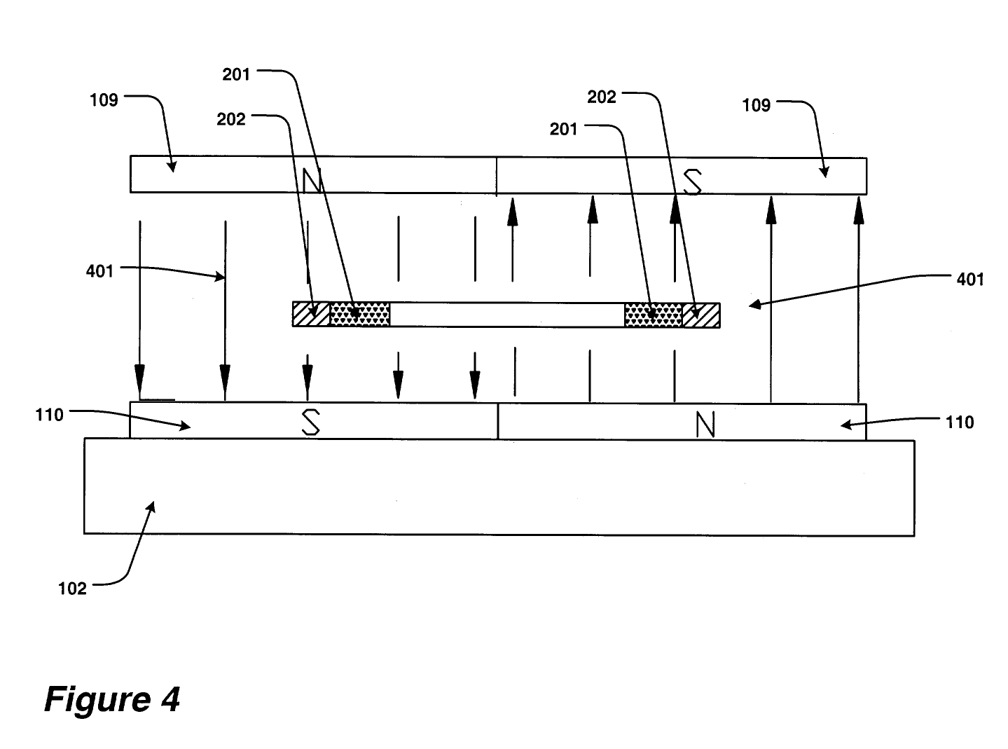

FIG. 5 illustrates one embodiment of an actuator driving mechanism as constructed in the present invention.

FIG. 6 illustrates in an exploded view one embodiment of the head actuator mechanism.

FIG. 7 illustrates in a perspective view one embodiment of the head actuator mechanism.

FIG. 8 illustrates in a perspective view one embodiment of the assembled hard disk drive.

FIG. 9 illustrates in a top view one embodiment of the assembled hard disk drive.

### DETAILED DESCRIPTION

An actuator driving mechanism and a method of manufacture for that mechanism are disclosed. In one embodiment, the actuator driving mechanism includes a statically located stator generating a variable magnetic field to act upon a mobile rotator generating a permanent magnetic field. In a further embodiment, the stator includes a set of driving coils to generate the variable magnetic field and the rotator includes a permanent magnet coupled to a holding frame.

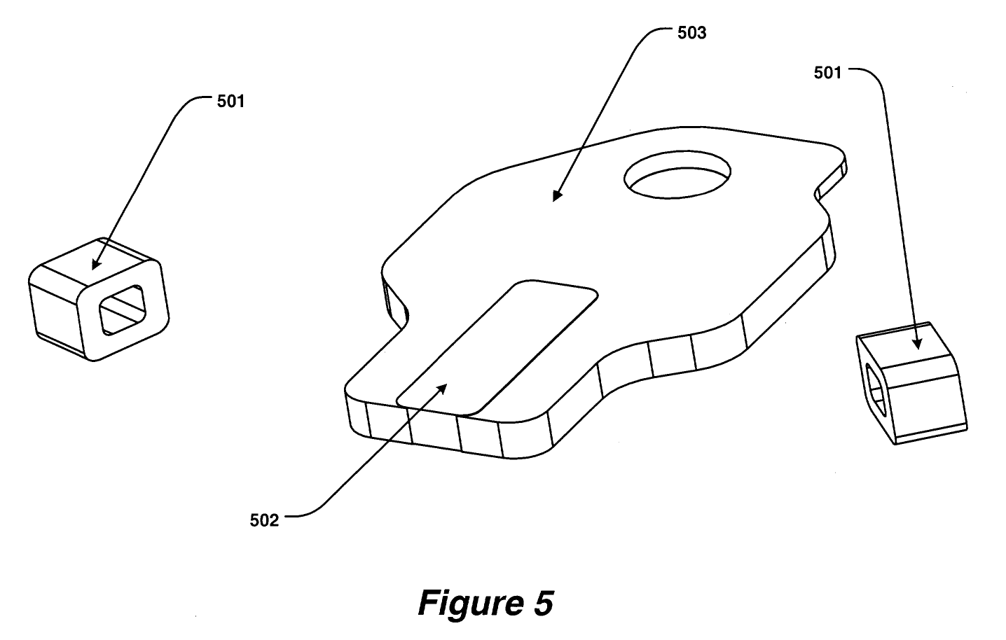

FIG. 5 illustrates one embodiment of an actuator driving mechanism as constructed in the present invention. In one embodiment, a statically located stator generates a variable magnetic field that acts on a rotator having a permanent magnetic field, causing the rotator to move tangentially to an axis of a pivot assembly attached to one end of the rotator. In one embodiment, the stator is a driving coil 501 with multiple windings. In a further embodiment, the individual windings are placed on either side of the rotator, the windings attached to an inner enclosure of the hard disk drive base. A current is passed through the driving coils 501 to create a first magnetic field. In an alternate embodiment, a single driving coil is positioned to one side of the rotator, the magnetic field varied by controlling the current flow through the single coil 501. The first magnetic field acts upon a second magnetic field generated by the rotator. The magnitude of the first magnetic field can be altered adjusting the current through the driving coils 501. In one embodiment, reversing the flow of current through the driving coils 501 reverses the direction of the rotator. In an alternate embodiment, each coil is set up to create a magnetic field in an opposing direction from the magnetic field created by the other coil. The coil that is given current depends on which direction the holding frame is to be moved. In one embodiment, the rotator includes a permanent magnet 502 and a holding frame 503. In a further embodiment, the holding frame 503 is made of plastic by injection molding.

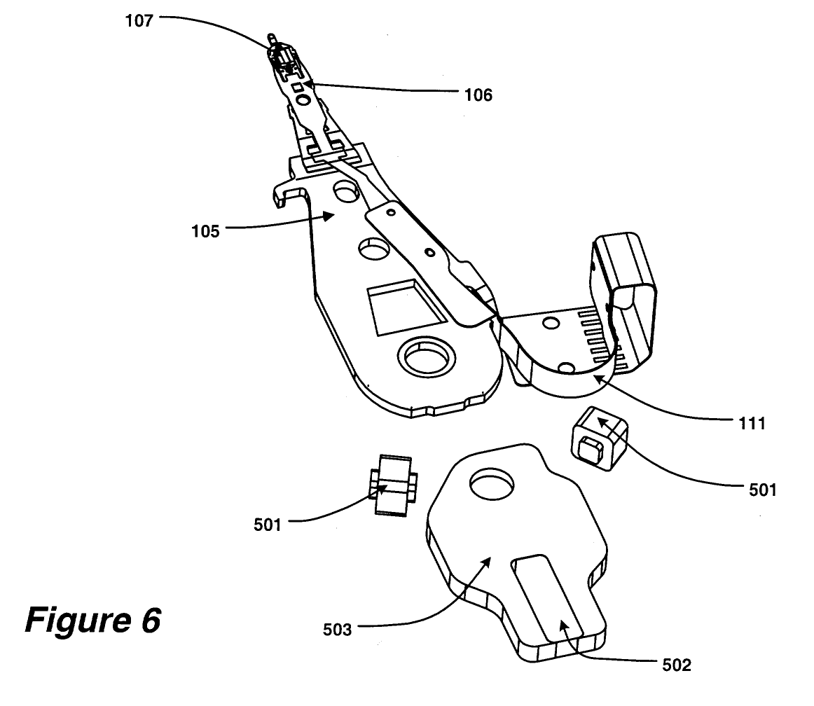

FIG. 6 illustrates in an exploded view one embodiment of the head actuator mechanism. In one embodiment, the actuator driving mechanism includes a stator and a rotator. In a further embodiment, the rotator includes a permanent magnet 502 coupled to a holding frame 503. The stator includes a driving coil 501 positioned on either side of the permanent magnet and the holding frame 503. In one embodiment, the HGA includes an actuator arm 105 coupled to a loadbeam 106. In a further embodiment, the actuator arm 105 is coupled to the loadbeam 106 by laser welding. In this embodiment, the magnetic read/write head 107 is coupled to the end of the loadbeam. A relay flexible printed circuit 111 allows a board unit 112 to control the magnetic read/write head 107.

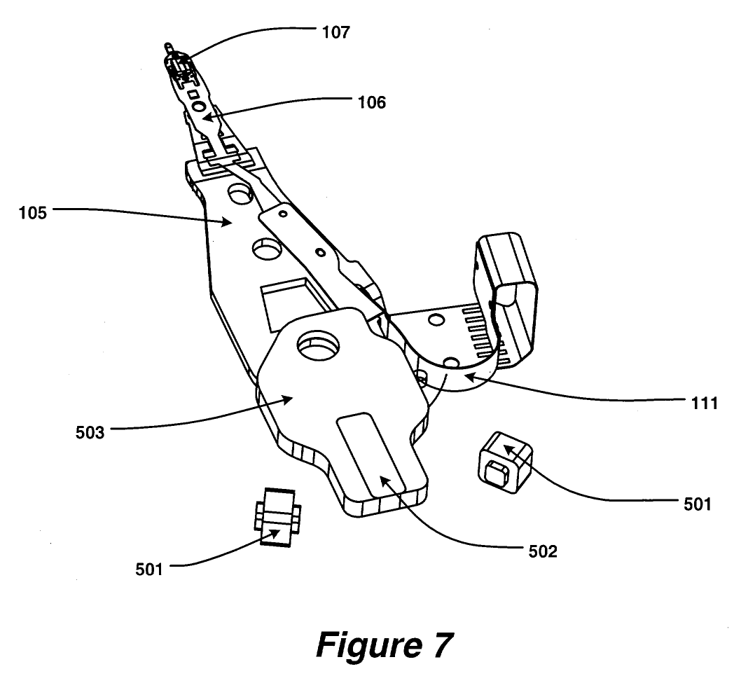

FIG. 7 illustrates in a perspective view one embodiment of the head actuator mechanism. In one embodiment, the actuator driving mechanism is coupled directly to the HGA. The stator of the actuator driving mechanism causes the rotator of the actuator driving mechanism to move in a tangential direction around a pivot assembly. The tangential movement of the rotator causes the HGA to move in the same tangential direction on the opposite side of the pivot assembly.

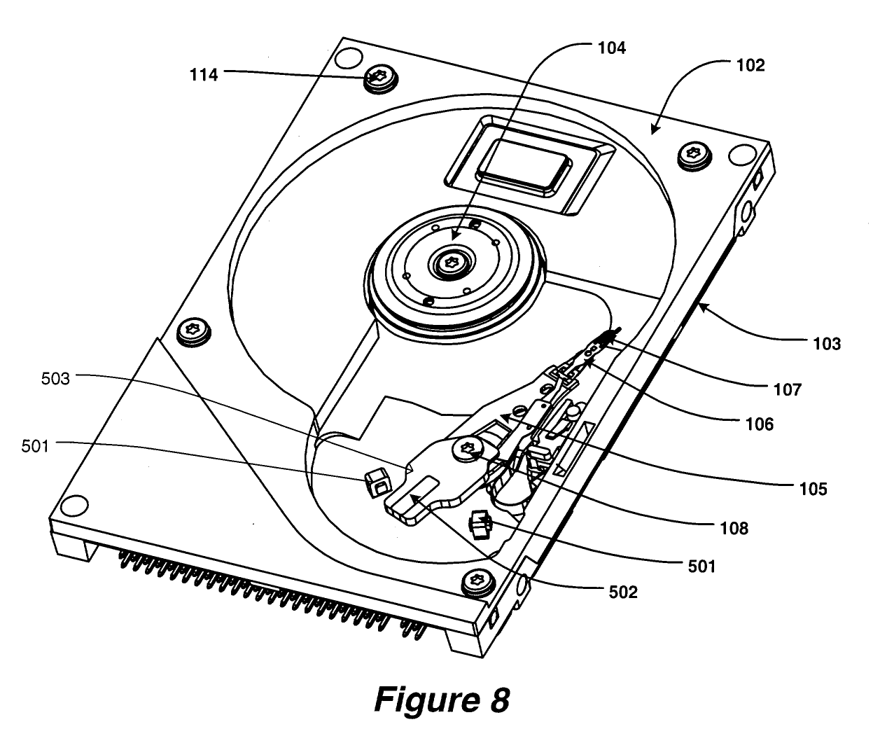

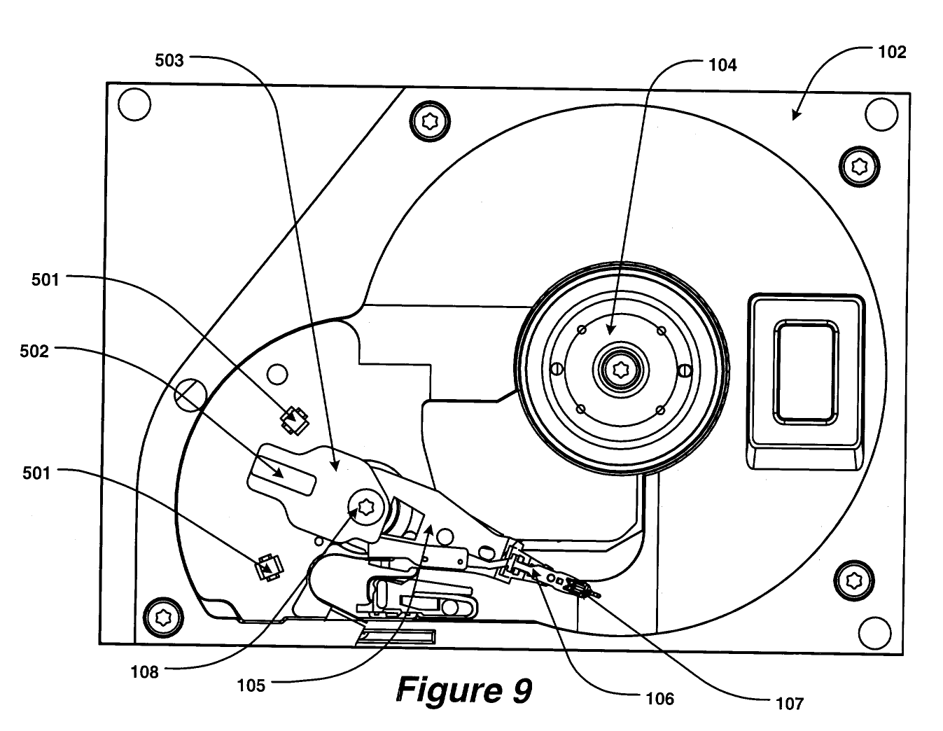

FIG. 8 illustrates in a perspective view one embodiment of the assembled hard disk drive. The pivot assembly 108 couples the actuator driving mechanism and the HGA to the disk drive base 102. As part of the actuator driving mechanism, driving coils 501 are positioned on either side of the rotator. In one embodiment, the driving coils 501 are attached to an inner enclosure of the base 102. The driving coils 501 act upon the frame 502, causing the rotator and the HGA to pivot around the pivot assembly 108. The HGA moves the magnetic read/write head 107 in a radial direction along the magnetic disk. FIG. 9 illustrates in a top view one embodiment of the assembled hard disk drive.

Although several embodiments are specifically illustrated and described herein, it will be appreciated that modifications and variations of the present invention are covered by the above teachings and within the purview of the appended claims without departing from the spirit and intended scope of the invention.

1. An actuator driving mechanism, comprising:
a stator having a static location to generate a variable magnetic field;
a pivot assembly to facilitate rotation around an axis; and
a rotator to generate a fixed magnetic field, the rotator coupled at one end to the pivot assembly so as to move tangentially around the axis.

2. The actuator driving mechanism of claim 1, wherein the stator comprises a voice coil with multiple windings, an individual winding positioned on opposing sides of the rotator.

3. The actuator driving mechanism of claim 2, wherein the individual windings are attached to an inner enclosure of a hard disk drive base.

4. The actuator driving mechanism of claim 1, wherein the rotator comprises:
a permanent magnet; and
a holding frame coupled to the permanent magnet.

5. The actuator driving mechanism of claim 4, wherein the holding frame is comprised of plastic.

6. The actuator driving mechanism of claim 5, wherein the holding frame is made by injection molding.

7. The actuator driving mechanism of claim 1, wherein the rotator is coupled to a head gimbal assembly.

8. A system, comprising:
a base to support the system;
a disk containing data;
a spindle motor coupled to the base to rotate the disk relative to the base;
a head gimbal assembly coupled to a top support face of the ball bearing assembly;
a magnetic read/write head to read the data from the disk;
a stator having a static location to generate a variable magnetic field;
a pivot assembly to facilitate rotation around an axis; and
a rotator to generate a fixed magnetic field, the rotator coupled at one end to the pivot assembly so as to move tangentially around the axis.

9. The system of claim 8, wherein the head gimbal assembly includes:
a loadbeam coupled to the magnetic read/write slider head; and
a support arm to couple the loadbeam to the bearing assembly.

10. The system of claim 9, wherein the loadbeam is coupled to the support arm by laser welding.

11. The system of claim 8, wherein the stator comprises a voice coil with multiple windings, an individual winding positioned on opposing sides of the rotator.

12. The system of claim 9, wherein the individual windings are attached to an inner enclosure of a hard disk drive base.

13. The system of claim 8, wherein the rotator comprises:
a permanent magnet; and
a holding frame coupled to the permanent magnet.

14. The system of claim 13, wherein the holding frame is comprised of plastic.

15. The system of claim 14, wherein the holding frame is made by injection molding.

16. A method, comprising:
generating a variable magnetic field with a stator having a static location;
generating a fixed magnetic field with a rotator coupled at one end to a pivot assembly; and
moving the rotator around an axis of the pivot assembly by varying the variable magnetic field of the stator.

17. The method of claim 16, wherein the stator comprises a voice coil with multiple windings.

18. The method of claim 17, further comprising positioning an individual winding of the voice coil on opposing sides of the rotator.

19. The method of claim 18, further comprising attaching the individual windings to an inner enclosure of a hard disk drive base.

20. The method of claim 16, wherein the rotator comprises:
a permanent magnet; and
a holding frame coupled to the permanent magnet.

21. The method of claim 20, further comprising manufacturing the holding frame from plastic.

22. The method of claim 20, further comprising manufacturing the holding frame by injection molding.

23. The method of claim 16, further comprising coupling the rotator to a head gimbal assembly.
